(19) United States
(12) Patent Application Publication
(10) Pub. No.: US 2013/0180800 A1
(43) Pub. Date: Jul. 18, 2013

(54) Method and apparatus for a compact descender

(71) Applicant: Kirk Martin Mauthner, Wilmer (CA)

(72) Inventor: Kirk Martin Mauthner, Wilmer (CA)

(21) Appl. No.: 13/374,797

(22) Filed: Jan. 17, 2012

(51) Int. Cl. A62B 1/14; B23P 11/00

(52) U.S. Cl. 182/5; 29/428

(57) ABSTRACT

Method and Apparatus for a Compact Descender used in conjunction with a rope. The invention includes a first plate and a second plate arranged adjacent to one another and pivotally connected to one another by a rope post at the top ends of the first plate and the second plate. The first plate and the second plate are selectively and pivotally opened and closed and are interlocked when closed by attachment of a carabiner through a hole in the bottom end of the first plate and an adjacent hole in the bottom end of the second plate. The first plate and the second plate include a rope channel adjacent to a lever, where the lever is pivotally attached to a pivot pin affixed to the first plate. A substantially rectangular shaped rope clamping cam is pivotally attached above the lever on the same pivot pin.

### FIELD OF INVENTION

This invention relates generally to a method and device for descending on a rope and more particularly, to a compact auto clamping rope descender with lever action release or belay for a single person load. It can also be used as a “ratchet” or “progress capture” in an ascent system or within a pulley system.

### BACKGROUND

Rope descenders as used for descending when rock climbing, rescuing or, professional ski guides, or for mission specific military special operations or, tactical operations personnel purposes, are generally well known, whereas the present invention offers unique properties, the advantages of which are listed below in the Summary of the Invention.

Past inventions that include descenders and which incorporate some or part of the basics of the present invention are numerous. Inventors are aware of U.S. Pat. No. 6,902,031 issued to Ador, Jun. 7, 2005 entitled, Personal safety device for a vertical rope; U.S. Pat. No. 5,850,893 issued to Hede, et al., Dec. 22, 1998 entitled, Self-locking descender for a rope with an operating lever; U.S. Pat. No. 5,577,576 issued to Petzl, et al. Nov. 26, 1996 entitled, Disengageable descender with self-locking of the rope; U.S. Pat. No. 5,054,577 issued to Petzl, et al. Oct. 8, 1991 entitled, Self-jamming descender for a rope with two jamming positions; and U.S. Pat. No. 4,580,658 issued to Brda Apr. 8, 1986 entitled Device for lowering a person or a load on a rope; all of which are listed here for reference purpose only.

### SUMMARY OF THE INVENTION

This unique design of rope descender allows a more compact personal use configuration comprising a rectangular shaped cam, combined with 360 degrees of wrap around the cam, along with an adjacent friction post or rope post and the connectivity of the lever to the cam, and further combining the unique compound angle lever and V-groove arrangement that achieves maximum control in a personal use device.

In using compact descender the rope is loaded by swinging the front plate to fully expose the rectangular shaped cam and rope channel. The rope is wrapped 360 degrees counter-clockwise around the rectangular cam, with both the standing part and running end (the free end) exiting on the left hand side of the cam and rope post. Close the front plate such that the front and rear plate carabiner holes align and the running end of the rope is positioned in the V-groove shape formed by the two plates when closed.

Clip a locking carabiner through both holes and then orient the compact descender with the lever facing away from the body; then clip the carabiner through to the rappel loop of the harness. Ensure that the running end is still in the V-groove, apply a firm grip to the running end with one hand, and with the other hand wrap it around the device placing the palm of your hand on the lever and your thumb on the other side of the device. Slowly squeeze the lever in towards the device to initiate descent. The desired rate of descent is achieved by a combination of how far the lever is squeezed and how firmly the running end is gripped.

Maximum rate of descent occurs when the lever has rotated the cam away from the rope post. If the lever is rotated further, friction is then applied to the rope by the lever forcing the running end rope further into the V-groove thereby providing an additional means of descent control.

It should be mentioned that the compact descender can also be used to lower a person rather than rappelling. The mechanics of descent control for lowering are essentially the same as rappelling except that the descender is clipped to an anchor instead of to the rappel loop. It can also be used as a “progress capture” in an ascent system or within a pulley system.

A principal object of the invention is to provide a compact device that is versatile, enabling various descending and other uses when combined with additional mechanical riggings.

Another object of the invention is to provide an apparatus that can be quickly and easily attached to a rope and easily enabled into use. Another object of the present invention is to provide an improved device where the compact size makes it easy to carry.

A further object is to provide a device that is durable in use and yet cost effective to market.

The present invention has other objects and features of advantage, which will become apparent from and are set forth in more detail in the description and the accompanying drawings.

### BRIEF DESCRIPTION OF DRAWINGS

Advantages of the present invention will become more fully appreciated as the same becomes better understood when considered in conjunction with the following detailed description of an illustrative embodiment and accompanying drawings, in which like reference characters designate the same or similar parts throughout the several views, wherein:

FIG. 1 is a front perspective view of the apparatus for a compact descender according to the preferred embodiment of the present invention.

FIG. 2 is a front perspective view of the apparatus for a compact descender according to the preferred embodiment of the present invention, where the device is in the open, or rope loading position.

FIG. 3 is an exploded front perspective view shown from above, of the apparatus for a compact descender according to the preferred embodiment of the present invention.

FIG. 4 is an exploded plan view of the apparatus for a compact descender according to the preferred embodiment of the present invention.

FIG. 5a shows a rear elevational view of the preferred cam shape, FIG. 5b is a side elevational view the preferred cam shape, FIG. 5c is an exploded perspective view the preferred cam shape showing the dowel pin, and FIG. 5d is a perspective view showing the dowel pin pressed into the cam.

FIG. 6a is a side elevation view and 6b is a bottom plan view of the apparatus for a compact descender according to the preferred embodiment of the present invention showing how the lever rotates down to press the rope into the V-groove.

FIG. 7 is a front elevational view of the apparatus for a compact descender according to the preferred embodiment of the present invention, where the device is in the open position, showing a rope loaded in the rope channel, around the cam and passing by the rear plate lower end.

### DETAILED DESCRIPTION OF THE PREFERRED EMBODIMENTS

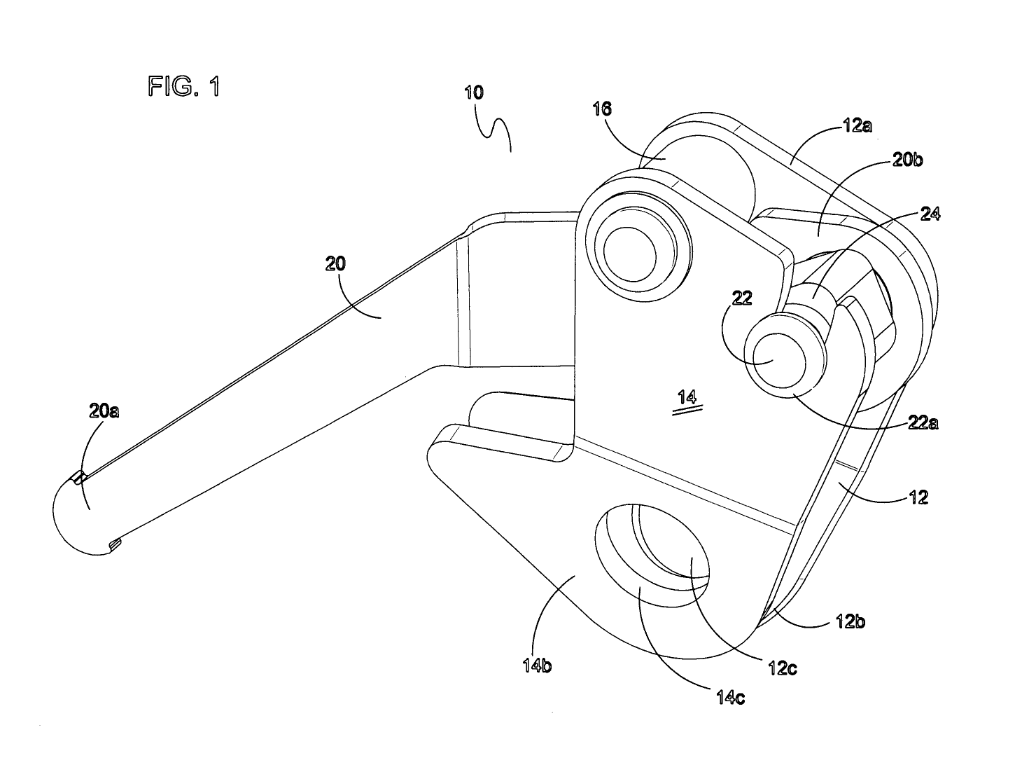

Referring to FIG. 1 where a front perspective view shows the compact descender apparatus, which is generally referred to here as device 10. Device 10 includes a rear plate 12 and a front plate 14. Rear plate 12 has a top end 12a and a bottom end 12b. Front plate 14 has a top end 14a and a bottom end 14b. Rear plate 12 and a front plate 14 are arranged opposing one another and are pivotally connected to one another by a rope post 16. Device 10 includes a rope channel 18. Adjacent to rope channel 18 is a lever 20, lever 20 includes a handle end 20a and a pivot end 20b, where lever pivot end 20b is pivotally attached to rear plate 12 by a pivot pin 22. Also pivotally attached to pivot pin 22 is a rope clamping cam 24. Pivot pin 22 includes a shoulder 22a to increase rigidity of device 10 when rear plate 12 and the front plate 14 are interconnected in the closed position. Also, when rear plate 12 and the front plate 14 are in the closed position holes 12c and 14c are align with one another for interlocking of rear plate 12 and the front plate 14 by a carabiner clip (not shown).

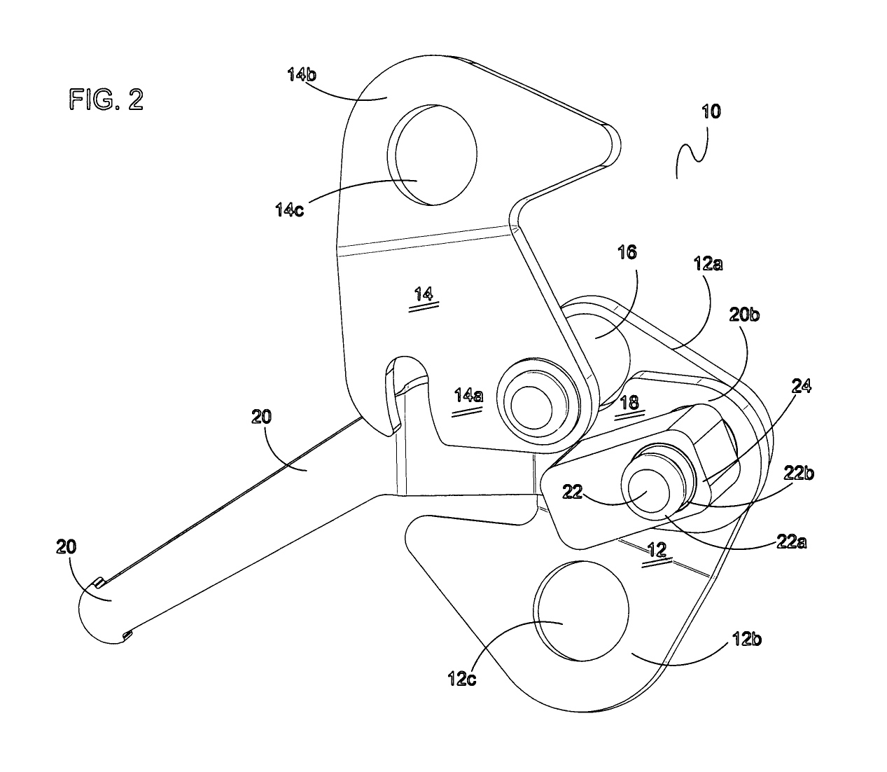

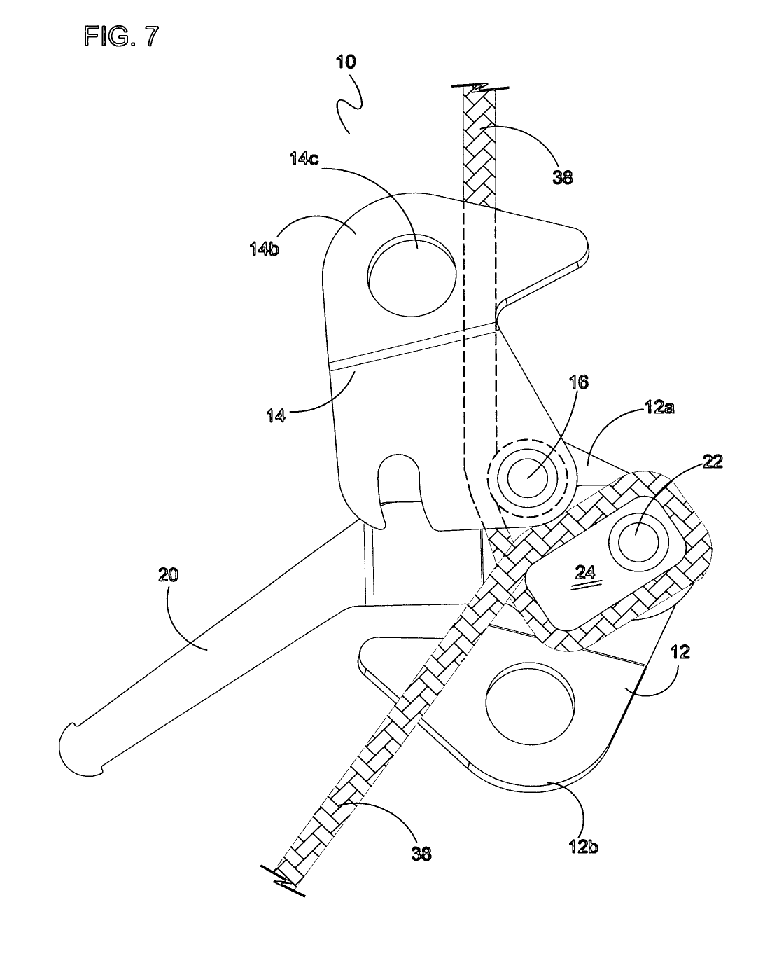

In FIG. 2 a front perspective view of the ascender device shows the device 10 in the open or rope loading position. Rear plate 12 and front plate 14 are pivotally opened to load a rope (not shown). When loading a rope, the rope will pass through rope channel 18 as is shown loaded in FIG. 7.

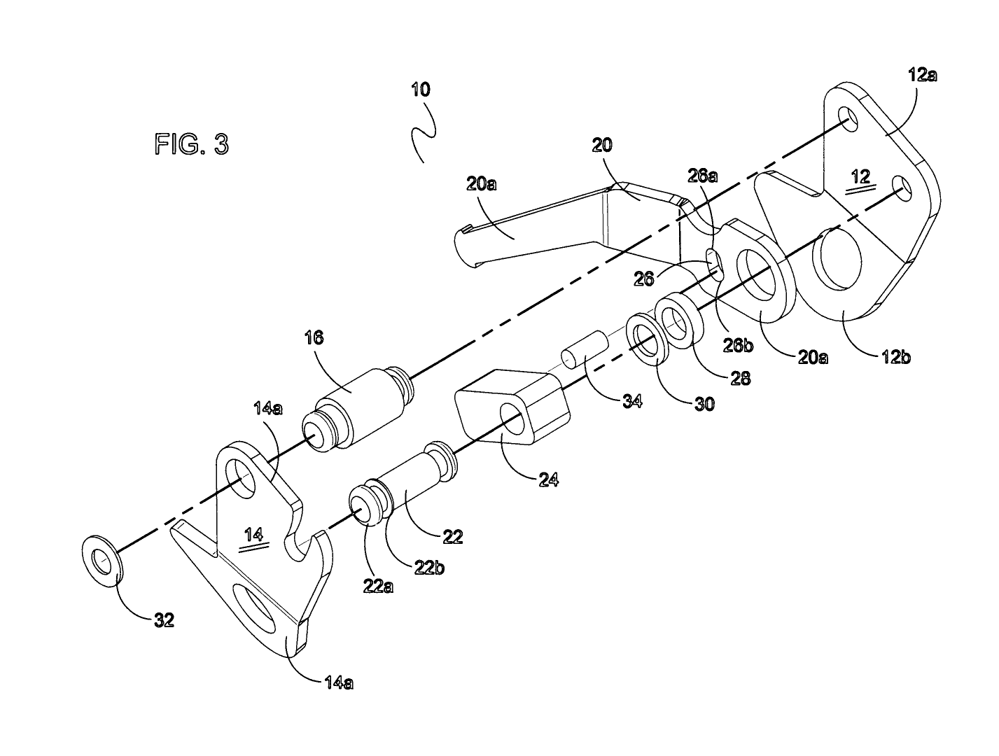

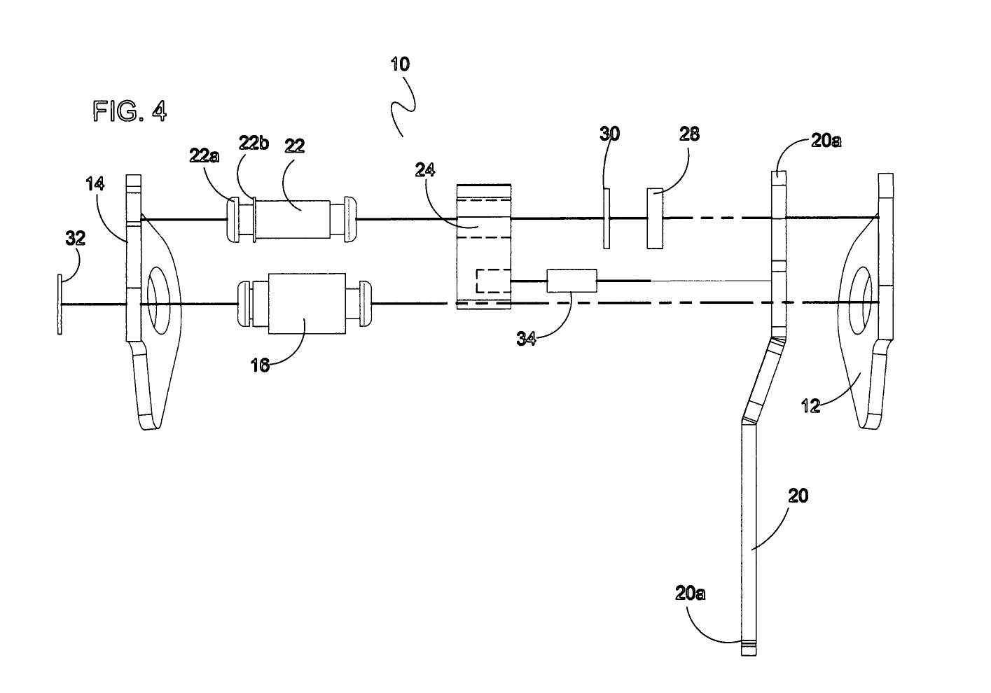

FIG. 3 is an exploded front perspective view shown from above, where all the parts of device 10 can be better seen. Note that rope post 16 and pivot pin 22 are shown spun to a mushroomed head, as they would be after assembly of device 10. Lever 20 has a slot 26 end 26a and end 26b. Also shown in FIG. 3 and FIG. 4 are lever bushing 28 and cam spacer 30 that prevent binding of the lever 20 and cam 24. Lever 20, lever bushing 28 and cam spacer 30 are made of separate materials preferably brass, bronze or stainless steel. Also shown here is a washer 32, where washer 32 prevents front plate 14 from binding to rope post 16 after being spun to a mushroomed head. Washer 32 fits in rope post relieve 16a.

FIG. 4 is an exploded plan view, where all the parts can be easily seen. Again, rope post 16 and pivot pin 22 are shown being spun to a mushroomed head as they would be after assembly of device 10. Also shown in FIG. 3 and FIG. 4 pivot pin 22 includes lip 22b, where lip 22b keeps cam 24 positioned on pin 22, when front plate 14 is open.

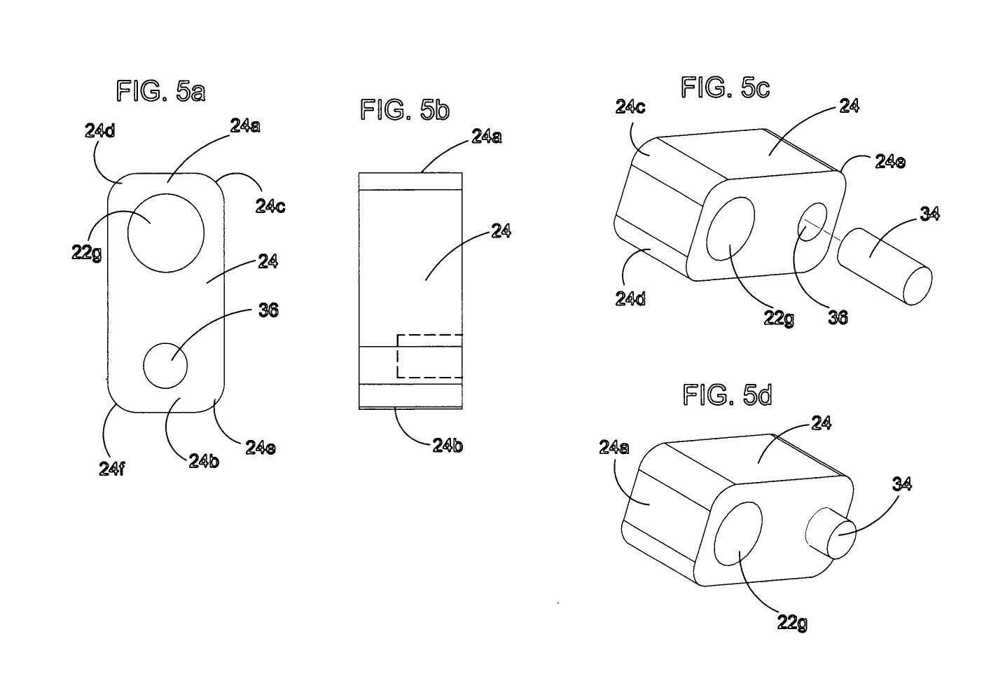

FIG. 5a shows a rear side elevational view of the rectangular shaped rope clamping cam 24. Rope clamping cam 24 incorporates a radius on corners of the rectangular shape, 24c, 24d, 24e and 24f, where the radius is between 10% and 35% of the working width (across the ends 24a and 24b) of cam 24, where the rope drag or friction is affected. Rope clamping cam 24 includes pivot pin hole 22g for mounting cam 24 onto pivot pin 22. FIG. 5b is a side elevational view the cam 24, FIG. 5c is an exploded perspective view rectangular cam 24, showing a dowel pin 34, and FIG. 5d is a perspective view showing dowel pin 34 pressed into hole 36 in cam 24.

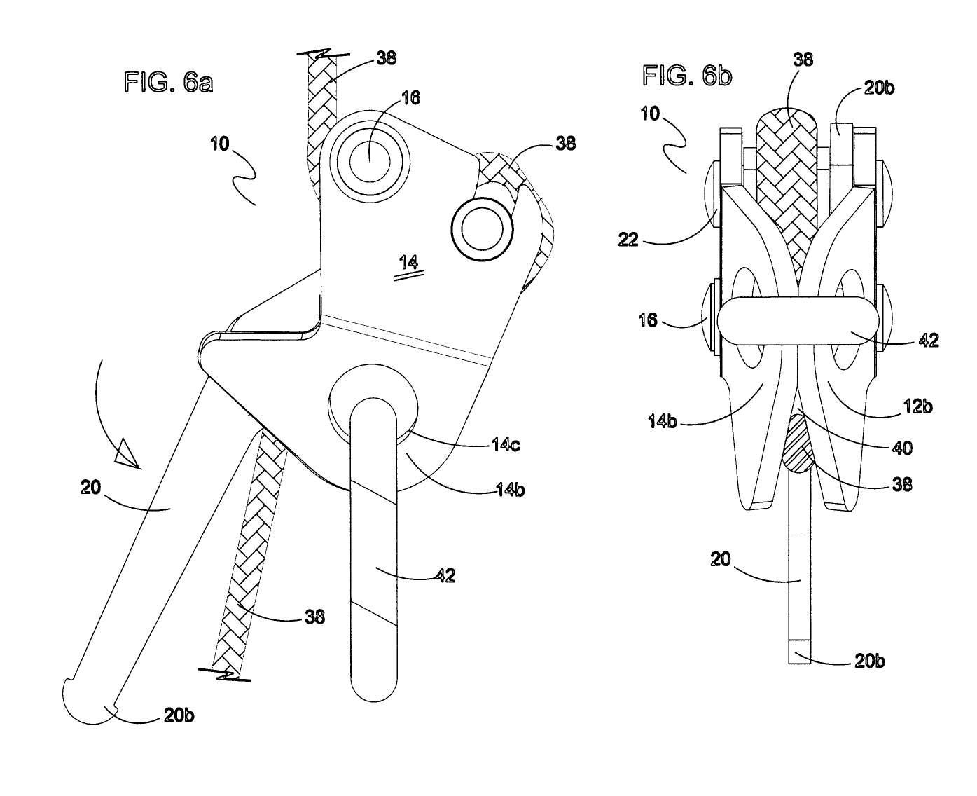

FIG. 6a is a side elevation view and 6b is a bottom plan view showing how the compound angled lever 20 rotates down to press rope 38 into V-groove 40. Rear plate 12 and front plate 14 are interlocked when closed by means of carabiner 42.

FIG. 7 is a front elevational view, where the device is in the open position showing a rope threaded into rope channel 18, around cam 24 and passing by rear plate lower end 12b. Note that rope 38 is wrapped 360 degrees around cam 24. Cam 24 is automatically activated by friction of the rope acting on cam 24, causing rotation of cam 24, with pin 34 moving within slot 26 clamping the rope against rope post 16 without movement of lever 20.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. While the invention has been described in its preferred embodiments, it is to be understood that the words which have been used are words of description and not of limitation. Therefore, changes may be made within the appended claims without departing from the true scope of the invention.

It is intended that the scope of the invention be defined by the Claims appended hereto and their equivalents, which should be given their fair and fullest scope.

What is claimed is:

1. A compact descender apparatus used in conjunction with a rope, comprising:
a first plate and a second plate, said first plate and said second plate having an inside surface and an outside surface, a top end and a bottom end, where said first plate and said second plate are arranged adjacent one another with said inside surfaces facing one another and said first plate and said second plate are pivotally connected to one another by a rope post at said top ends of said first plate and said second plate, where said first plate and said second plate are selectively and pivotally opened and closed on said rope post, said first plate and said second plate are interlocked when closed by attachment of a link through a hole in said bottom end of said first plate and an adjacent hole in said bottom end of said second plate, where said first plate and said second plate include a rope channel defined therebetween; adjacent said rope channel and therebetween said first plate and said second plate is a lever, said lever having a back surface and a front surface, a handle end and a pivot end, where said lever pivot end is pivotally affixed by a pivot pin to said inside surface of said first plate therebetween said first plate and said second plate, wherein said pivot pin is affixed to said inside surface of said first plate adjacent said rope post and alongside said rope channel; and
adjoined on said front surface at said pivot end of said lever is a rope clamping cam, said rope clamping cam pivotally mounted on said pivot pin, said rope clamping cam having a first side, a second side, a pivot end and a clamping end, where said clamping end of said clamping cam automatically makes contact with said rope against said rope post by friction of said rope on said cam.

2. The compact descender apparatus for a rope as defined in claim 1, where said apparatus includes a rope V-groove defined therebetween said first plate and said second plate at said bottom end of said first and said second plates as said first plate and said second plate are in said closed position, where said V-groove increases friction on said rope when said clamping cam is selectively rotated away from said rope post by rotation of said lever when descending.

3. The compact descender apparatus for a rope as defined in claim 1, wherein said clamping cam is substantially rectangular shaped, and where said rope clamping cam has a radius on all four rope contact corners where said radii are from 10% to 35% of the working width of said substantially rectangular cam.

4. The compact descender apparatus for a rope as defined in claim 1, wherein said first plate and said second plate are further interlocked when rotated to said closed position, by a shoulder on said pivot pin accepted by an opening slot therein said second plate.

5. The compact descender apparatus for a rope as defined in claim 1, wherein said clamping clamp is selectively deactivated rotationally by a dowel pin affixed to said clamping cam and adjacent to said clamping cam end and attached to said first side of said clamping cam facing said lever, and where said lever includes a slot adjacent said pivot end of said lever, where said slot having a first end and a second end is of a defined length, where said first end of said slot allows said cam independent movement of said clamping cam to automatically apply a pre-determined pressure to said rope when tension is applied to said rope, and where said second end of said slot in said lever contacts said dowel pin when said lever is rotated away from said rope post, to selectively rotated said clamping cam to selectively release said rope from said rope post, said rope being threaded through said rope channel and around said clamping cam.

6. The compact descender apparatus for a rope as defined in claim 1, wherein said lever includes a compound angle thereon said lever, and wherein said lever includes a bushing between said pivot pin and said lever, where said bushing is made of a separate material than said lever and said pivot pin, such as brass or stainless steel.

7. A method of a compact descender for a rope method comprising the steps of:
a) forming a first plate and a second plate, both having an inside surface and an outside surface, a top end and a bottom end;
b) arranging said first plate and said second plate adjacent one another with said inside surfaces facing one another;
c) pivotally connecting said first plate and said second plate one to another by a rope post at said top ends of said first plate and said second plate;
d) said first plate and said second plate are selectively and pivotally opened and closed, where said first plate and said second plate are interlocked when closed by attachment of a link through a hole in said bottom end of said first plate and an adjacent hole in said bottom end of said second plate;
e) mounted to said inside surface of said first plate adjacent said rope post and therebetween said first plate and said second plate is a pivot pin;
f) defined therebetween said first plate and said second plate and therebetween said pivot pin and said rope post is a rope channel;
g) pivotally attached to said pivot pin and adjacent said rope channel and therebetween said first plate and said second plate is a lever, said lever having a back surface and a front surface, a handle end and a pivot end;
h) said lever pivot end is pivotally attached to said pivot pin next to said inside surface of said first plate and therebetween said first plate and said second plate;
i) pivotally mounting a rope clamping cam to said pivot pin, adjoining said front surface of said lever at said pivot end of said lever, said rope clamping cam having a first side, a second side, a pivot end and a clamping end;
j) threading a rope past said rope post, through said rope channel, wrapping said rope once 360 degrees around said rope clamping cam, and threading said rope down past said first plate lower end and said second plate lower end;
k) automatically activating said rope clamping cam by friction of said rope thereon said rope clamping cam, causing rotation of said rope clamping cam thereby clamping said rope against said rope post;
l) rotating said clamping cam by selectively rotating said lever thereby rotating said rope clamping cam away from said rope post, selectively releasing said rope from said rope post thereby descending.

8. The method of a compact descender for a rope as defined in claim 7, wherein forming of said first plate and forming of said second plate includes forming a rope V-groove being defined therebetween said first plate and said second plate at said bottom end of said first plate and said bottom end said second plates as said first plate and said second plate are in said closed position, thereby increasing friction on said rope within said V-groove by further selective rotation of said lever when descending.

9. The method of a compact descender for a rope as defined in claim 7, wherein said clamping cam is shaped to a substantially rectangular shaped, and where said rope clamping cam shaping includes a radius on all four rope contact corners where said radii are from 10% to 35% of the working width of said substantially rectangular cam.

10. The method of a compact descender for a rope as defined in claim 7, wherein said first plate and said second plate are further interlocked when rotated to said closed position, by shaping a shoulder on said pivot pin accepting an opening slot formed therein said second plate.

11. The method of a compact descender for a rope as defined in claim 7, further comprising the step of affixing a dowel pin to said clamping cam adjacent to said clamping cam end facing said lever, forming a slot of a defined length in said pivot end of said lever, said slot having a first end and a second end, where said first end of said slot allows independent movement of said clamping cam to automatically apply a pre-determined pressure to said rope on said rope post when applying tension to said rope, and when rotating said lever away from said rope post, said dowel pin contacts said second end of said slot in said lever thereby selectively rotating said clamping cam away from said rope post to selectively release said rope from said rope post, thereby descending.

12. The method of a compact descender for a rope as defined in claim 7, further comprising the step of forming said lever to a compound angle, and adding a bushing to said lever therebetween said pivot pin and said lever, and making said bushing of a separate material than said lever and said pivot pin, such as brass or stainless steel, preventing binding of said lever with said pivot pin.
